(19) United States
(12) Patent Application Publication
(10) Pub. No.: US 2008/0057275 A1
(43) Pub. Date: Mar. 6, 2008

(54) Method and apparatus for minimizing oxidation pitting of refractory metal vessels

(76) Inventors: Paul Richard Grzesik, Corning, NY (US); David Myron Lineman, Painted Post, NY (US); William Brashear Mattingly, Painted Post, NY (US)

Correspondence Address: CORNING INCORPORATED, SP-TI-3-1, CORNING, NY, 14831, US

(21) Appl. No.: 11/513,869

(22) Filed: Aug. 31, 2006

(51) Int. Cl. B41M 5/00; C03B 11/00

(52) U.S. Cl. 428/195.1; 428/457; 428/688; 428/334; 65/227

(57) ABSTRACT

A method of reducing accelerated metal loss from the inner refractory metal of a component of a glass making system. The method utilizes a sacrificial metal member which saturates free volume regions surrounding the component with an oxide vapor of the sacrificial metal member.

### FIELD OF THE INVENTION

This invention is directed to a method of reducing oxidation of refractory metal vessels in contact with molten glass, and in particular, accelerated oxygen pitting of piping and other refractory metal vessels in a glass making operation.

### TECHNICAL BACKGROUND

Formed glass is often considered to be a relatively inert material. Indeed, glass vessels often serve as containers in a vast array of different industries. However, during the glass manufacturing process the glass is conveyed at very high temperature (in excess of 1600° C. in some cases. At temperatures this hot, the glass itself can be quite corrosive, thus requiring a corrosion-resistant system of piping and containment. Moreover, the high temperature results in rapid corrosion of many materials. Of particular concern is oxidation of the material. Corrosive oxidation can lead to failure of the material, and the oxidation products may contaminate the glass. For this reason, most containment and transfer systems for molten glass rely upon vessels constructed from high melting temperature, oxidation resistant refractory metals such as vessels fabricated from the platinum group metals and alloys thereof, including, but not limited to platinum itself, rhodium, iridium and palladium. Platinum group metals are resistant to oxidation, and have sufficiently high melting temperatures to make them an attractive choice for the containment of molten glass.

In spite of their advantages, however, the platinum group metals, such as commonly employed platinum, and their alloys, tend to be quite expensive, thus, every effort is made to limit the overall use of the metal. One cost saving measure is to make the refractory metal portion of the vessel as thin as practical, while providing structural strength through other methods. For example, many refractory metal vessels used in a modern glass making operation are encased in a ceramic jacket, sometimes referred to as “castable”. The castable serves several functions. As noted, it provides mechanical strength to the vessel. Secondarily, it also limits contact between the vessel and the ambient atmosphere. Although resistant to oxidation at low temperature, at high temperature (e.g. temperatures in excess of about 1000° C.), most precious metals used in refractory applications, such as platinum group metals, are nevertheless susceptible to oxidation.

In some instances, additional measures to protect the vessel(s) from corrosion include providing a primary coating overtop the vessel, between the castable and the vessel. As is the case with the castable, the coating tends to be composed of a ceramic material.

In spite of the foregoing precautions, refractory metal vessels, even those fabricated from platinum group metals, are not oxidation proof and eventually fail. Examination of failed refractory metal vessels has lead to the observation that the castable, and/or the ceramic coating, may be susceptible to cracking, particularly in areas prone to mechanical shock, joints, and other high-stress regions of the system. These cracks may further extend through the castable/coating to the surface of the refractory metal vessel, leading to localized oxidation of the vessel's outside surface. This oxidation is significantly accelerated when compared to the corrosion rate of the general surface, resulting in oxygen pitting of the vessel walls. Eventually, this pitting leads to rapid failure of the vessel.

What is needed is a method of reducing accelerated oxygen pitting of the refractory metal vessel(s) used to convey and hold molten glass, thereby extending the lifetime of the vessel.

### SUMMARY

It is an object of the present invention to provide a method for reducing failure of vessels used to convey or hold molten glass through accelerated oxygen pitting of refractory metals used in the fabrication of such vessels.

It is another object of the present invention to provide a vessel comprising a refractory metal which resists oxygen pitting of the refractory metal and exhibits an extended useful lifetime.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods features and advantages be included within this description, be within the scope of the present invention, and be protected by the accompanying claims.

In accordance with one embodiment of the present invention, a glass making system is disclosed comprising a vessel for conveying or holding molten glass comprising an inner layer comprising a metal selected from the group consisting of ruthenium, rhodium, palladium, osmium, iridium, platinum, rhenium molybdenum and alloys thereof, a barrier layer adjacent at least a portion of the inner layer, a source of a metal oxide gas proximate the barrier layer, the source comprising a metal selected from the group consisting of ruthenium, rhodium, palladium, osmium, iridium, platinum and rhenium, and wherein the source of metal oxide gas is separate from the inner layer.

In another embodiment, a vessel for conveying or holding molten glass is described comprising an inner layer for contacting the molten glass comprising a metal selected from the group consisting of ruthenium, rhodium, palladium, osmium, iridium, platinum, rhenium, molybdenum and alloys thereof, a barrier layer adjacent the inner layer, a sacrificial metal member for forming a metal oxide gas adjacent at least a portion of the barrier layer, the sacrificial metal member selected from the group consisting of ruthenium, rhodium, palladium, osmium, iridium, platinum, rhenium, molybdenum and alloys thereof.

In still another embodiment, a method of reducing oxidation pitting of a vessel for contacting a molten glass is disclosed comprising providing a vessel for contacting molten glass comprising an inner layer formed from a metal selected from the group consisting of ruthenium, rhodium, palladium, osmium, iridium, platinum, rhenium, molybdenum and alloys thereof, and further comprising a barrier material adjacent a surface of the inner layer, saturating a region adjacent the barrier material with a metal oxide gas wherein the metal of the metal oxide gas is selected from the group consisting of ruthenium, rhodium, palladium, osmium, iridium, platinum, rhenium and molybdenum, and a source of the metal oxide gas is separate from the inner layer.

The invention will be understood more easily and other objects, characteristics, details and advantages thereof will become more clearly apparent in the course of the following explanatory description, which is given, without in any way implying a limitation, with reference to the attached Figures. It is intended that all such additional methods, features and advantages be included within this description, be within the scope of the present invention, and be protected by the accompanying claims.

### BRIEF DESCRIPTION OF THE DRAWINGS

FIG. 1 is a cross sectional elevated view of a glass making system comprising refractory metal components.

FIG. 2 is a cross sectional image of a portion of a platinum rhodium alloy vessel used in a glass making system such as that shown in FIG. 1 depicting accelerated oxidation (pitting) of the alloy.

FIG. 3A-3B are cross sectional views of a portion of an exemplary vessel for contacting molten glass without the benefit of the present invention (FIG. 3A) and illustrating accelerated loss of refractory metal from the vessel (FIG. 3B).

FIG. 3C-3D are cross sectional views of a portion of an exemplary vessel having the benefit of the present invention (FIG. 3C) and illustrating (FIG. 3D) a much reduced amount of metal loss in comparison with the vessel of FIG. 3B.

FIG. 4 is a perspective view of a portion of a vessel for contacting molten glass (shown in cross section) wherein a sacrificial metal member is in the form of a wire mesh.

FIG. 5 is a perspective view of a portion of a vessel for contacting molten glass (shown in cross section) wherein a sacrificial metal member is in the form of “dots” of metal.

FIG. 6 is a perspective view of a portion of a vessel for contacting molten glass (shown in cross section) wherein a sacrificial metal member is in the form of metal particles dispersed within a supporting jacket.

FIG. 7 is a cross sectional elevated view of a glass making system wherein a portion of the system is contained within an enclosure for controlling a partial pressure of oxygen within the enclosure.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

Piping and other vessels (e.g. fining vessel, stir chamber, etc) used in the glass making industry are often fabricated from high melting temperature, oxidation resistant refractory metals. Such metals are typically so-called precious or noble metals, and therefore expensive. Of particular importance as refractory metals are the platinum group metals: ruthenium, rhodium, palladium, osmium, iridium and platinum, and alloys thereof. Their resistance to chemical attack and their excellent high temperature performance have lead to extensive use of platinum group metals in various refractory applications. However, it should be understood that the methods described herein are applicable to other non-platinum group metals, including many of the transition metals, such as, for example, molybdenum or rhenium, or alloys thereof.

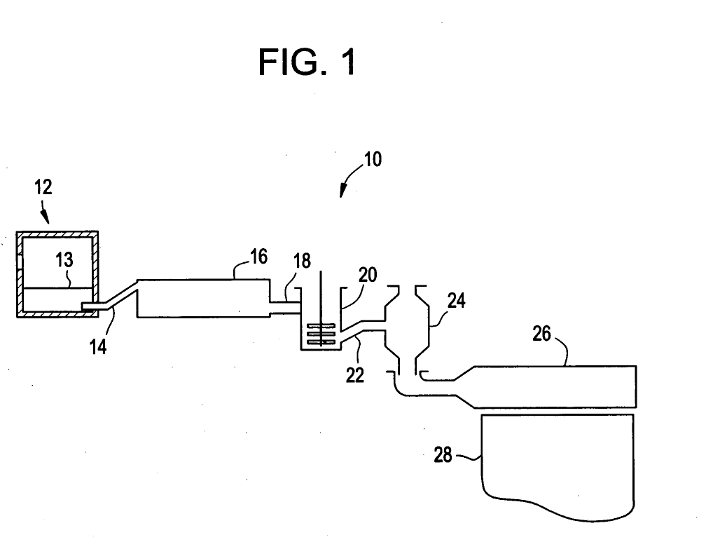

Illustrated in FIG. 1 is a typical downdraw glass manufacturing system 10 used in the manufacture of glass sheets, such as in the fabrication of liquid crystal displays (LCDs), organic light emitting diode (OLED) displays and the like. The system depicted in FIG. 1 comprises melting tank or melter 12 for forming molten glass 13, melter to fining vessel connector 14, fining vessel 16, fining vessel to stirrer connector 18, stirrer 20, stirrer to downcomer connector 22, downcomer 24, and forming wedge (isopipe) 26 from which glass sheet 28 is drawn. While the melter and the isopipe are typically formed of a refractory ceramic material, much of the transfer system between the melter and the isopipe comprise refractory metal components. These include the various connector pipes 14, 18, 22, the finer 16, stirrer 20 and downcomer 24. Many of these metal components are encased in a structural ceramic material that provides strength and rigidity to the refractory metal components. However, while this jacket, sometimes referred to as the “castable”, slows oxidation of the outside surface of the various refractory metal vessels, it is nonetheless brittle and susceptible to mechanical damage, typically in the form of small cracks. These cracks may appear spontaneously over the surface of the castable, but tend to concentrate in regions of high stress, such as joints between components. The cracks in the castable jacket breach the protective capability of the jacket, and may consequently lead to rapid oxidation of the refractory metal vessel in the immediate proximity of the crack. For this reason, the refractory metal components of the glass making system may be further coated with an additional ceramic coating (barrier layer), such as alumina or zirconia, for minimizing oxidation of the refractory metal. Of course it should be noted that the application of the present invention is not limited to downdraw methods of glass forming, but may be used in any application where corrosion protection of refractory metal vessels is desired.

In spite of the precautions noted above, it has been found that such secondary coatings may themselves be susceptible to cracking, and while effective in preventing overall corrosion of the vessel surface, the secondary coating may in fact, in some cases, exacerbate corrosion of the refractory metal vessel surface by inducing oxygen pitting (i.e. pitting of the surface of the refractory metal via selective and accelerated oxidation).

For example, volatilization of platinum above 1200° C., as an oxide, is proportional to the partial pressure of oxygen to which the platinum is exposed. Thermodynamically, the equilibrium between the metal, oxygen and the gaseous oxide may be expressed as

xM+½yO₂⇄MₓO_{y} (1)

where M represents the metal. The equilibrium constant k may be written as

k=p(MₓO_{y})/(p(O₂)^{1/2y}a(M)^{x}) (2)

where a(M) is the activity of the metal M and p represents a partial pressure.

When a steady, measured flow of an inert carrier gas is passed over a refractory metal specimen maintained at a constant temperature, vapor of the metal is removed at a rate which is dependent upon the partial pressure of the vapor. At low flow rates, the carrier gas is more likely to be saturated with the vapor because the contact time between the carrier gas and the sample is longer. If, over a range of flow rates the same mass of volatile metal species is transported for a given volume of gas, then the carrier gas is considered to be perfectly saturated. Put another way, if the mass loss is directly proportional to the flow rate, then the gas is saturated. If the mass loss is independent of the gas flow rate, then the gas is unsaturated.

Without wishing to be bound by theory, it is believed that under low flow or quasi static conditions, the refractory metal oxide saturates the volume around the test sample, providing an “equilibrium” loss rate, and the loss of metal is directly proportional to the gas flow rate in this regime. As long as the gas remains saturated, the amount of metal loss remains a function of how quickly the saturated gas is being removed. As flow rates are increased, a point may be reached where the metal oxide vapor cannot maintain saturation of the volume surround the sample and the regime switches to a “non-equilibrium” regime. In the non-equilibrium regime the metal loss rate is determined by other mechanisms, such as surface desorption rate. The non-equilibrium loss rate is independent of gas flow rate but dependant on the geometry of the setup: (1) the free space volume above the refractory metal surface; and (2) the amount of open, non-occluded metal surface area bordering the free space volume.

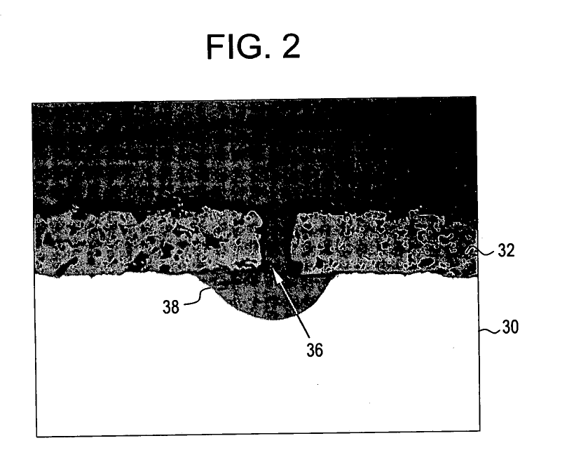

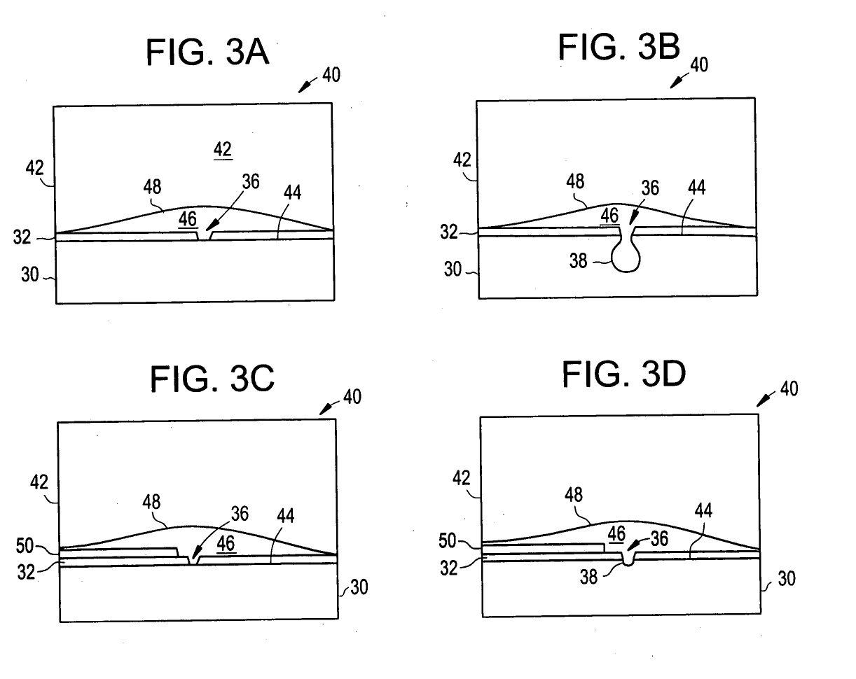

Refractory metal samples with larger surface areas of exposed metal and smaller free space volumes will maintain a saturated environment more easily and require a higher gas flow rate before switching to a non-equilibrium metal loss regime. In contrast, large free space volumes relative to the area of non-occluded metal surface will switch to non-equilibrium metal loss rates even at low gas flow rates. This latter case is representative of the situation when cracks are present in the protective ceramic layer. Cracks represent a small area of exposed metal which favors metal loss at the non-equilibrium rate. Thus two samples under the same temperature, flow rates and oxygen partial pressures can have very different metal loss rates, since the metal loss rate is also dependent on the geometrical setup variables mentioned above. Indeed, it has been found that a refractory metal vessel (e.g. a platinum rhodium alloy) covered by a protective ceramic coating can experience metal loss at sites where the ceramic coating is cracked which are 5× higher than unprotected areas of the vessel. It is believed that this high rate of loss is due to the environment surrounding the region of the crack being in the “non-equilibrium loss regime. Such a metal loss can be seen by examining FIG. 2 showing a portion of an actual vessel for molten glass comprising a refractory metal. Shown in FIG. 2 is a cross sectional view of a portion of an actual inner refractory metal layer (platinum-rhodium alloy) 30 of a working finer 16 coated with a barrier layer 32 and supported by jacket 42 (not shown in FIG. 2. See for example FIGS. 3A-3D). In the instance of FIG. 2, barrier layer 32 is a ceramic barrier layer. Crack 36 breaches barrier layer 32, and oxidation of the inner refractory metal layer 30 can be seen as manifesting in pit 38. The oxygen pitting depicted in FIG. 2 occurred after only 30 days at a temperature of about 1670° C., and pit 38 is approximately 0.006 inches (0.15 mm) deep.

In accordance with an embodiment of the present invention, a method to drive the metal loss into a slower “equilibrium” loss rate regime and reduce oxidation of the refractory metal layer in contact with the glass is presented whereby a free space volume above a protective coating or barrier layer is saturated with an oxide of the refractory metal. Thus, cracks which may later form in the barrier layer expose the underlying refractory metal inner layer to the refractory metal oxide saturated atmosphere.

FIG. 3A shows a cross sectional view of a small section of an exemplary vessel 40 used to transport molten glass comprising an inner refractory metal layer 30 for contacting the molten glass, a protective barrier layer 32 for preventing oxidation of the inner refractory metal layer, and a structural jacket 42 for providing support and rigidity to the inner layer. Inner refractory metal layer 30 preferably comprises ruthenium, rhodium, palladium, osmium, iridium, platinum, rhenium, molybdenum or alloys thereof. For example, inner layer 30 may be a platinum rhodium alloy consisting of a majority metal (e.g. platinum, in an amount of between about 70% and 80% by weight) and a minority metal (e.g. rhodium, in an amount of between 30% and 20% by weight).

Barrier layer 32 is disposed adjacent to outer surface 44 of refractory metal layer 30. Barrier layer 32 may be a flame sprayed or a plasma sprayed refractory oxide, or any other coating intended to provide oxidation protection of the refractory metal inner layer. For example, barrier layer 32 may comprise alumina or zirconia. Structural jacket 42 is disposed about barrier layer 32 and largely in contact with barrier layer 32. Structural jacket 42 is preferably formed from a refractory oxide suitable for slurry casting. A suitable refractory oxide may be, for example, alumina or zirconia

FIG. 3A is shown with a crack 36 in barrier layer 32, thereby exposing inner layer 30 to atmosphere 46 contained within interstitial void 48 between barrier layer 32 and jacket 42. FIG. 3B illustrates the effect of oxygen contained within the atmosphere, producing an accelerated loss of the refractory metal of inner layer 30 of vessel 40 through oxidation, and subsequent formation of pit 38.

In accordance with an embodiment of the present invention and depicted in FIG. 3C, vessel 40 is provided with a sacrificial metal member 50 is provided between barrier layer 32 and jacket 42 such that sacrificial metal member 50 is available, in the presence of oxygen in atmosphere 46, to produce an oxide of the metal of the sacrificial member into a free volume space (i.e. void 48) which may exist between barrier layer 32 and jacket 42, and thereby saturating volume 48 with the oxide. Practicing the invention may then produce the result illustrated in FIG. 3D wherein an effective equilibrium condition exists between the loss of refractory metal from inner layer 30, and reversion of the lost metal back into inner layer 30 according to equation (1) above. The result is significantly reduced oxidation of inner layer 30 relative to the oxidation which may occur without benefit of the present invention. This can be seen by comparing the relative sizes of the oxidation pitting of FIG. 3B and FIG. 3D.

It should be understood that although FIGS. 3A-3D are shown with a crack in barrier layer 32, the existence of the crack (or other form of a breach of barrier layer 32), is not a pre-existing condition of the present invention. That is, the present invention comprises embodiments which serve to protect the vessel in the event of a breach of the barrier layer.

Sacrificial metal member 50 should have as a constituent a metal which comprises inner layer 30, preferably a metal selected from ruthenium, rhodium, palladium, osmium, iridium, platinum, rhenium and alloys thereof. Sacrificial member 50 may be in the form of a sheet of metal disposed proximate barrier layer 32, or sacrificial metal member 50 may, for example, be a mesh or screen, paste or foil. If inner layer 30 is an alloy, sacrificial metal member 50 should include a majority constituent which is the same as the majority constituent of the inner layer alloy. For example, in the case where inner layer 30 is an 80% platinum 20% rhodium alloy, the majority constituent of the sacrificial metal member should be platinum. The weight percent makeup of sacrificial metal member 50 need not be the same as the composition of inner layer 30 however. In this particular example, the sacrificial metal member could be 100% platinum.

It is not necessary that the sacrificial metal member be excessively thick, and may be, for example, less than about 50 microns thick. However, the sacrificial metal member or members may have a thickness on the order of hundreds of microns, or more, albeit at higher cost. Preferably, the sacrificial metal member, particularly if in the form of a layer, is less than about 500 μm thick.

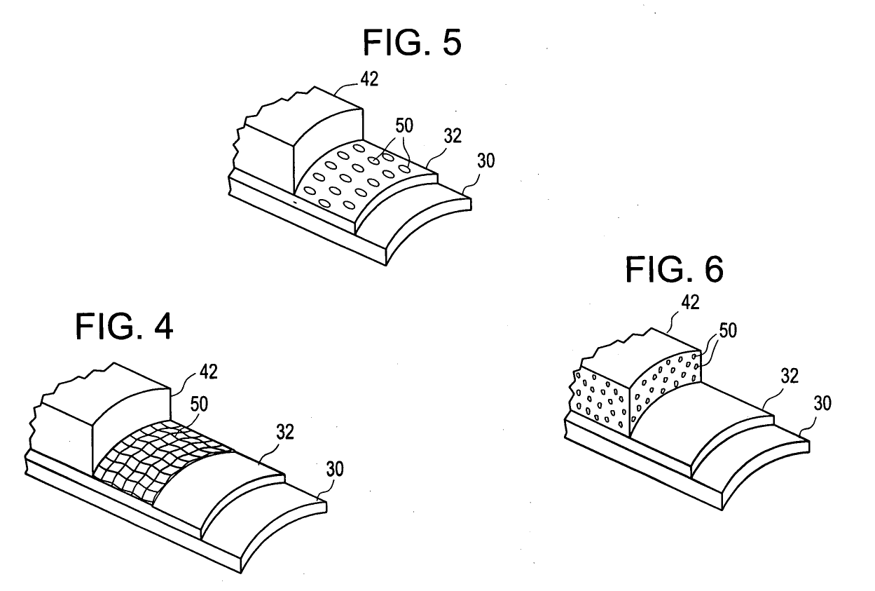

Indeed, the form and placement of the sacrificial metal member is a tradeoff between the ability to provide the sacrificial metal member proximate a location on barrier layer 32 most likely to develop a crack which may expose the underlying inner refractory metal layer 30 to oxidation, and the added cost of the additional metal. Ideally, one may wrap the entire system in a layer of sacrificial metal member, thus anticipating a crack at any point. However, this practice must be weighed against the cost of the additional, and generally expensive, refractory metal. To this end, several solutions may be applied, including reducing the amount of sacrificial metal member while still maintaining a significant surface area coverage, such as by employing a metal mesh, or applying the sacrificial metal member layer only in those areas where cracks are most likely to occur (e.g. transition joints/couplings, areas prone to vibration or other mechanical shock, etc.). These two philosophies are not mutually exclusive and may be applied simultaneously. That is, the sacrificial metal member 50 that is applied to selected high-risk areas prone to cracking could be a metal mesh which minimizes the amount of sacrificial metal member needed, while maximizing the overall protected surface area as depicted in FIG. 4.

The sacrificial metal member may be applied in a number of ways, depending upon the form and the composition of the metal. For example, as previously described the metal could be a layer, and applied by plasma spraying, flame spraying, sputtering, or even wrapping as a foil layer.

In another variant, depicted in FIG. 5, the sacrificial metal member may be discontinuous. Thus, sacrificial metal member 50 could be applied, for example, as discontinuous “dots” of metal arranged on the surface of barrier layer 32. Such dots could be macroscopic, or they could be microscopic, such as sprayed particulate which nevertheless forms a discontinuous coating. FIG. 5 shows a partial cross section of a cylindrical vessel, in perspective, illustrating dots of sacrificial metal applied to barrier layer 32. Typically, spacing between such dots should be on the order of the thickness of the dots. Moreover, it is not necessary that the sacrificial metal member be in direct and/or intimate contact with barrier layer 32, although this is a simpler method of application. It is only desired that the sacrificial metal member be exposed to an atmosphere which may itself come in contact with the refractory metal of inner layer 30. Thus, sacrificial metal member 50 may be in the form of metal particles (e.g. a powder) mixed or otherwise dispersed within the material of jacket 42, for example, as shown in FIG. 6. However, this is generally a less desirable alternative, since the bulk of the sacrificial refractory metal particles would be embedded within the jacket material and unavailable to react with free oxygen to produce an oxide of the metal proximate the barrier layer.

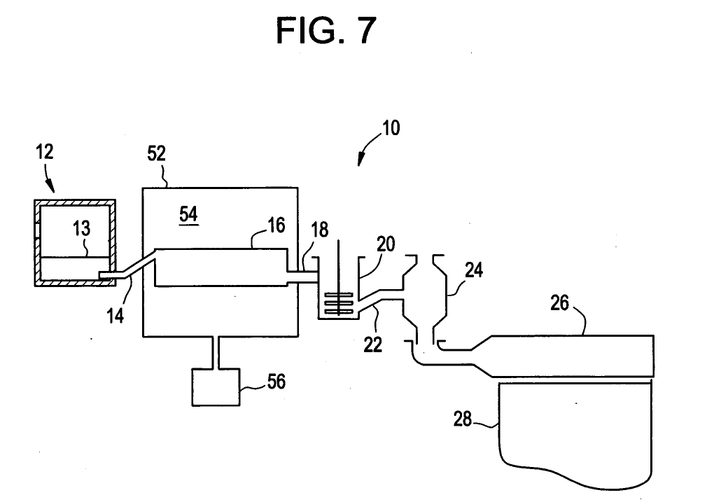

In still another embodiment of the present invention illustrated in FIG. 7, the use of a sacrificial metal member may be combined with surrounding the refractory vessel, such as finer 16 shown in FIG. 7, with an enclosure 52 wherein atmosphere 54 within the enclosure is controlled by atmospheric controller 56 to have a reduced partial pressure of oxygen. Reducing or eliminating oxygen in the atmosphere within enclosure 52 surrounding the vessel (finer 16 in FIG. 7), and saturating interstitial free space regions between jacket 42 and barrier layer 32 with metal oxide gas, ensures that only a small amount, if any, of oxygen is available for oxidation of the refractory metal inner layer of the vessel. Atmospheric controller 56 can be, for example, a known device for controlling the dew point of atmosphere 54.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A glass making system comprising
a vessel for contacting molten glass comprising an inner layer comprising a metal selected from the group consisting of ruthenium, rhodium, palladium, osmium, iridium, platinum, rhenium, molybdenum and alloys thereof;
a barrier layer adjacent at least a portion of the inner layer;
a source of a metal oxide gas proximate the barrier layer, the source comprising a metal selected from the group consisting of ruthenium, rhodium, palladium, osmium, iridium, platinum, rhenium and molybdenum; and
wherein the source of metal oxide gas is separate from the inner layer.

2. The glass making system according to claim 1 wherein the barrier layer comprises a ceramic.

3. The glass making system according to claim 1 wherein the metal of the inner layer and the source of the metal oxide gas have the same composition.

4. The glass making system according to claim 1 wherein the source of metal oxide gas contacts the barrier layer.

5. The glass making system according to claim 2 wherein the source of metal oxide gas is discontinuous.

6. The glass making system according to claim 1 wherein the vessel is enclosed within an enclosure and a partial pressure of oxygen within the enclosure is controlled.

7. The glass making system according to claim 1 wherein the source of metal oxide gas comprises a layer disposed about at least a portion of the vessel.

8. The glass making system according to claim 7 wherein a thickness of the layer is less than about 500 μm.

9. The glass making system according to claim 1 wherein the source of metal oxide gas comprises a wire mesh.

10. The glass making system according to claim 1 wherein the source of metal oxide gas is included in a jacket disposed about the barrier layer.

11. A method of reducing oxidation pitting of a vessel in a glass making system comprising:
providing a vessel for conveying or holding molten glass comprising an inner layer formed from a metal selected from the group consisting of ruthenium, rhodium, palladium, osmium, iridium, platinum, rhenium, molybdenum and alloys thereof, and further comprising a barrier material adjacent a surface of the inner layer;
saturating a region adjacent the barrier material with a metal oxide gas wherein the metal of the metal oxide gas is selected from the group consisting of ruthenium, rhodium, palladium, osmium, iridium, platinum, rhenium and molybdenum; and
a source of the metal oxide gas is separate from the inner layer.

12. The method according to claim 11 wherein the barrier material comprises alumina or zirconia.

13. The method according to claim 11 wherein the source of the metal oxide gas is a sacrificial metal member proximate at least a portion of the barrier material.

14. The method according to claim 11 further comprising controlling a partial pressure of oxygen in an atmosphere surrounding the vessel.

15. A vessel for contacting molten glass comprising:
an inner layer for contacting the molten glass comprising a metal selected from the group consisting of ruthenium, rhodium, palladium, osmium, iridium, platinum, rhenium, molybdenum and alloys thereof;
a barrier layer adjacent the inner layer;
a sacrificial metal member for forming a metal oxide gas adjacent at least a portion of the barrier layer, the sacrificial metal member selected from the group consisting of ruthenium, rhodium, palladium, osmium, iridium, platinum, rhenium, molybdenum and alloys thereof.

16. The vessel according to claim 15 wherein the sacrificial metal member is discontinuous.

17. The vessel according to claim 15 wherein the sacrificial metal member is a wire mesh.

18. The vessel according to claim 15 wherein the sacrificial metal member has a layer having a thickness less than about 500 μm.

19. The vessel according to claim 15 wherein the barrier layer is a ceramic material.

20. The vessel according to claim 15 further comprising a jacket material surrounding the barrier layer for providing rigidity to the vessel.
